(19) United States
(12) Patent Application Publication
(10) Pub. No.: US 2024/0423275 A1
(43) Pub. Date: Dec. 26, 2024

(54) AEROSOL-GENERATING DEVICE WITH HEAT DISSIPATION

(71) Applicant: Philip Morris Products S.A., Neuchatel (CH)

(72) Inventor: Jiacun CAI, Huizhou (CN)

(73) Assignee: Philip Morris Products S.A., Neuchatel (CH)

(21) Appl. No.: 18/701,264

(22) PCT Filed: Oct. 22, 2021
(86) PCT No.: PCT/CN2021/125824

§ 371 Date: Apr. 15, 2024

(51) Int. Cl. A24F 40/46; H05B 3/22

(52) U.S. Cl. CPC A24F 40/46; H05B 3/22

(57) ABSTRACT

An aerosol-generating device is provided, including: a heating chamber; and a heat dissipation element arranged at least partly surrounding the heating chamber, the heat dissipation element being made from graphene. An aerosol-generating system including the aerosol-generating device and an aerosol-generating article including aerosol-forming substrate is also provided.

The present invention relates to an aerosol-generating device.

It is known to provide an aerosol-generating device for generating an inhalable vapor. Such devices may heat aerosol-forming substrate to a temperature at which one or more components of the aerosol-forming substrate are volatilised without burning the aerosol-forming substrate. Aerosol-forming substrate may be provided as part of an aerosol-generating article. The aerosol-generating article may have a rod shape for insertion of the aerosol-generating article into a cavity, such as a heating chamber, of the aerosol-generating device. A heating element may be arranged in or around the heating chamber for heating the aerosol-forming substrate once the aerosol-generating article is inserted into the heating chamber of the aerosol-generating device.

It would be desirable to have an aerosol-generating device which does not become too hot on the outside. It would be desirable to have an aerosol-generating device with improved heat dissipation.

According to an embodiment of the invention there is provided an aerosol-generating device that may comprise a heating chamber and a heat dissipation element. The heat dissipation element may be arranged at least partly surrounding the heating chamber. The heat dissipation element may be made from a material that dissipates heat predominantly in one or both of an axial and tangential direction with respect to a longitudinal axis of the heating chamber.

According to an embodiment of the invention there is provided an aerosol-generating device comprising a heating chamber and a heat dissipation element. The heat dissipation element is arranged at least partly surrounding the heating chamber. The heat dissipation element is made from a material that dissipates heat predominantly in one or both of an axial and tangential direction with respect to a longitudinal axis of the heating chamber.

Providing the heat dissipation element prevents the outside of the aerosol-generating device becoming too hot. Hence, user can safely touch the outside of the aerosol-generating device. Particularly advantageous is to dissipate the heat away from the heating chamber in an axial or tangential direction so that the heat can be dissipated into the rest of the device. In this way, the total temperature can be safely reduced and the overall heat can be dissipated to the environment without a certain spot of the aerosol-generating device becoming too hot.

The heat dissipation element may dissipate heat less in a radial direction than in the axial and tangential directions with respect to the longitudinal axis of the heating chamber.

The term ‘predominantly’ and ‘less’ preferably refer to the physical properties of the material of the heat dissipation element, particularly that heat dissipation is higher in at least one of an axial direction and a tangential direction of the heat dissipation element arranged at least partly surrounding the heating chamber than in a radial direction of the heat dissipation element. More preferably, heat dissipation is higher in at least one of the axial direction and the tangential direction in comparison with the radial direction by a factor of 2, preferably by a factor of 3, more preferably by a factor of 4, most preferably by a factor of 5.

The heat dissipation may be determined by measuring the temperature difference between one point of a material and a distanced second point. The higher the temperature difference, the higher the heat dissipation in the direction of the measurement points.

As a consequence, heat less from the heating chamber to the directly surrounding housing of the aerosol-generating device and more into the rest of the aerosol-generating device so that the overall heat is distributed more evenly throughout the aerosol-generating device.

The heat dissipation element may be configured as a layer. The heat dissipation element may form a layer at least partly surrounding the heating chamber.

The heat dissipation element may be made of graphene. Graphene has the advantage of having anisotropic characteristics concerning its thermal insulation properties. Thermal insulation is relatively poor in an X and Y direction, while thermal insulation is high in a Z direction. The graphene may be arranged surrounding the heating chamber such that the X and Y directions of the graphene correspond to the axial and tangential directions with respect to the longitudinal axis of the heating chamber. As a consequence, heat is dissipated well in the axial and tangential directions. The Z direction of the graphene corresponds to the radial direction with respect to the longitudinal axis of the heating chamber. As a consequence, heat is dissipated poorly in the radial direction such that the surrounding housing of the aerosol-generating device does not become too hot.

Generally, any heat dissipation element made from a material having anisotropic thermal insulation properties as described above with respect to graphene may be utilized to improve the transport of heat away from the heating chamber in an axial and tangential directions.

The heat dissipation element may fully surround the heating chamber. In other words, the heat dissipation elements may surround the outer periphery of the heating chamber.

The heat dissipation element may extend over the full length of the heating chamber. Preferably, the complete outer surface of the heating chamber is covered by the heat dissipation element.

The heat dissipation element may extend over the heating chamber in a distal direction. This has the advantage that heat is dissipated further into the aerosol-generating device such that the overall heat can be dissipated more uniformly into the ambient environment without creating any hotspots on the housing of the aerosol-generating device that may be unpleasant for a user to touch.

As used herein, the terms ‘upstream’, ‘downstream’, ‘proximal’ and ‘distal’ are used to describe the relative positions of components, or portions of components, of the aerosol-generating device in relation to the direction in which a user draws on the aerosol-generating device during use thereof.

As used herein, the term ‘axial’ refers to a direction along or parallel to the longitudinal axis of the heating chamber. The longitudinal axis of the heating chamber is preferably identical to the longitudinal axis of the aerosol-generating device or parallel to the longitudinal axis of the aerosol-generating device.

As used herein, the term ‘tangential’ refers to a direction along or parallel to a tangent with reference to the longitudinal axis of the heating chamber.

As used herein, the term ‘radial’ refers to a direction perpendicular to the axial direction and perpendicular to the tangential direction. This term refers to a direction in which the radius of the heating chamber would be measured by a person skilled in the art.

The heat dissipation element may be formed from one of a rectangular sheet, a T-shaped sheet and two connected rectangular sheets.

If the heat dissipation element is formed from a rectangular sheet, the dissipation element may only surround the heating chamber. Alternatively, the rectangular sheet can preferably be dimensioned such that the heat dissipation element surrounds the heating chamber as well as a portion of the area distal of the heating chamber. As described herein, heat may thus be dissipated more uniformly throughout the aerosol-generating device.

In case the heat dissipation element is formed from a T-shaped sheet, the ‘head’ of the sheet could be wrapped around the heating chamber, while the ‘stem’ of the sheet may further extend into the aerosol-generating device in a distal direction. Again, heater may more uniformly be dissipated into the aerosol-generating device by providing such a heat dissipation element.

Finally, the heat dissipation element may be formed from two connected rectangular sheets. In this embodiment, one of the rectangular sheets is preferably arranged surrounding the heating chamber, while the other rectangular sheet is arranged preferably distal of the heating chamber to dissipate heat more uniformly into the aerosol-generating device. The connection between the rectangular sheets guarantees that the heat can be transferred from the sheet wrapped around the heating chamber to the sheet distal of the heating chamber.

The aerosol-generating device may further comprise a heating element.

The heating element may comprise heating tracks, preferably consists of heating tracks.

The heating element may be arranged at least partly, preferably fully, surrounding the heating chamber.

In any of the aspects of the disclosure, the heating element may comprise an electrically resistive material. Suitable electrically resistive materials include but are not limited to: semiconductors such as doped ceramics, electrically “conductive” ceramics (such as, for example, molybdenum disilicide), carbon, graphite, metals, metal alloys and composite materials made of a ceramic material and a metallic material. Such composite materials may comprise doped or undoped ceramics. Examples of suitable doped ceramics include doped silicon carbides. Examples of suitable metals include titanium, zirconium, tantalum platinum, gold and silver. Examples of suitable metal alloys include stainless steel, nickel-, cobalt-, chromium-, aluminium-titanium-zirconium-, hafnium-, niobium-, molybdenum-, tantalum-, tungsten-, tin-, gallium-, manganese-, gold- and iron-containing alloys, and super-alloys based on nickel, iron, cobalt, stainless steel, Timetal® and iron-manganese-aluminium based alloys. In composite materials, the electrically resistive material may optionally be embedded in, encapsulated or coated with an insulating material or vice-versa, depending on the kinetics of energy transfer and the external physicochemical properties required.

The heating element may be configured as an external heating element being arranged at the wall of the heating chamber. An external heating element may take any suitable form. For example, an external heating element may take the form of one or more flexible heating foils on a dielectric substrate, such as polyimide. The flexible heating foils can be shaped to conform to the perimeter of the substrate receiving cavity. Alternatively, an external heating element may take the form of a metallic grid or grids, a flexible printed circuit board, a molded interconnect device (MID), ceramic heater, flexible carbon fibre heater or may be formed using a coating technique, such as plasma vapour deposition, on a suitable shaped substrate. An external heating element may also be formed using a metal having a defined relationship between temperature and resistivity. In such an exemplary device, the metal may be formed as a track between two layers of suitable insulating materials. An external heating element formed in this manner may be used to both heat and monitor the temperature of the external heating element during operation.

The heating element advantageously heats the aerosol-forming substrate by means of conduction. The heating element may be at least partially in contact with the substrate, or the carrier on which the substrate is deposited. Alternatively, the heat from either an internal or external heating element may be conducted to the substrate by means of a heat conductive element.

During operation, the aerosol-forming substrate may be completely contained within the aerosol-generating device. In that case, a user may puff on a mouthpiece of the aerosol-generating device. Alternatively, during operation a smoking article containing the aerosol-forming substrate may be partially contained within the aerosol-generating device. In that case, the user may puff directly on the smoking article.

The heating chamber may be formed by a dimensionally stable inner frame of the aerosol-generating device. The inner frame may define the heating chamber. The heating element may be mounted on the inner frame. The heating element may be arranged on an inner side wall of the heating chamber directly facing The aerosol-forming substrate. Alternatively, the heating element may be arranged at least partly surrounding the heating chamber. In any case, the heat dissipation element is preferably arranged at least partly surrounding the heating chamber as well as the heating element. In other words, the heating element is preferably arranged inside of the heat dissipation element.

The heating chamber may be arranged abutting a proximal end of the aerosol-generating device. Other elements of the aerosol-generating device may be arranged distal of the heating chamber. In other words, the aerosol-generating device may extend further distal of the heating chamber.

The heating chamber may have a cylindrical shape.

The heating chamber may be configured to receive an aerosol-generating article comprising aerosol-forming substrate.

The invention further relates to an aerosol-generating system comprising the aerosol-generating device described herein and an aerosol-generating article comprising aerosol-forming substrate.

The aerosol-generating device may comprise electric circuitry. The electric circuitry may comprise a microprocessor, which may be a programmable microprocessor. The microprocessor may be part of a controller. The electric circuitry may comprise further electronic components. The electric circuitry may be configured to regulate a supply of power to the heating element. Power may be supplied to the heating element continuously following activation of the aerosol-generating device or may be supplied intermittently, such as on a puff-by-puff basis. The power may be supplied to the heating element in the form of pulses of electrical current. The electric circuitry may be configured to monitor the electrical resistance of the heating element, and preferably to control the supply of power to the heating element dependent on the electrical resistance of the heating element.

The aerosol-generating device may comprise a power supply, typically a battery, within a main body of the aerosol-generating device. In one embodiment, the power supply is a Lithium-ion battery. Alternatively, the power supply may be a Nickel-metal hydride battery, a Nickel cadmium battery, or a Lithium based battery, for example a Lithium-Cobalt, a Lithium-Iron-Phosphate, Lithium Titanate or a Lithium-Polymer battery. As an alternative, the power supply may be another form of charge storage device such as a capacitor. The power supply may require recharging and may have a capacity that enables to store enough energy for one or more usage experiences; for example, the power supply may have sufficient capacity to continuously generate aerosol for a period of around six minutes or for a period of a multiple of six minutes. In another example, the power supply may have sufficient capacity to provide a predetermined number of puffs or discrete activations of the heating element.

As used herein, an ‘aerosol-generating device’ relates to a device that interacts with an aerosol-forming substrate to generate an aerosol. The aerosol-forming substrate may be part of an aerosol-generating article, for example part of a smoking article. An aerosol-generating device may be a smoking device that interacts with an aerosol-forming substrate of an aerosol-generating article to generate an aerosol that is directly inhalable into a user's lungs thorough the user's mouth. An aerosol-generating device may be a holder. The device may be an electrically heated smoking device. The aerosol-generating device may comprise a housing, electric circuitry, a power supply, a heating chamber and a heating element.

As used herein, the term ‘aerosol-generating article’ refers to an article comprising an aerosol-forming substrate that is capable of releasing volatile compounds that can form an aerosol. For example, an aerosol-generating article may be a smoking article that generates an aerosol that is directly inhalable into a user's lungs through the user's mouth. An aerosol-generating article may be disposable.

The aerosol-generating article may be substantially cylindrical in shape. The aerosol-generating article may be substantially elongate. The aerosol-generating article may have a length and a circumference substantially perpendicular to the length. The aerosol-generating article may be substantially rod shaped. The aerosol-forming substrate may be substantially cylindrical in shape. The aerosol-forming substrate may be substantially elongate. The aerosol-forming substrate may also have a length and a circumference substantially perpendicular to the length. The aerosol-forming substrate may be substantially rod shaped.

As used herein, the term ‘aerosol-forming substrate’ relates to a substrate capable of releasing one or more volatile compounds that can form an aerosol. Such volatile compounds may be released by heating the aerosol-forming substrate. An aerosol-forming substrate may conveniently be part of an aerosol-generating article or smoking article.

The aerosol-forming substrate may be a solid aerosol-forming substrate. The aerosol-forming substrate may comprise both solid and liquid components. The aerosol-forming substrate may comprise a tobacco-containing material containing volatile tobacco flavour compounds which are released from the substrate upon heating. The aerosol-forming substrate may comprise a non-tobacco material. The aerosol-forming substrate may comprise an aerosol former that facilitates the formation of a dense and stable aerosol. Examples of suitable aerosol formers are glycerine and propylene glycol.

If the aerosol-forming substrate is a solid aerosol-forming substrate, the solid aerosol-forming substrate may comprise, in some embodiments, one or more of: powder, granules, pellets, shreds, spaghettis, strips or sheets containing one or more of: herb leaf, tobacco leaf, fragments of tobacco ribs, reconstituted tobacco, homogenised tobacco, extruded tobacco, cast leaf tobacco and expanded tobacco. The solid aerosol-forming substrate may be in loose form, or may be provided in a suitable container or cartridge. Optionally, the solid aerosol-forming substrate may contain additional tobacco or non-tobacco volatile flavour compounds, to be released upon heating of the substrate. The solid aerosol-forming substrate may also contain capsules that, for example, include the additional tobacco or non-tobacco volatile flavour compounds and such capsules may melt during heating of the solid aerosol-forming substrate.

The aerosol-forming substrate is a substrate capable of releasing volatile compounds that can form an aerosol. The volatile compounds may be released by heating the aerosol-forming substrate. The aerosol-forming substrate may comprise plant-based material. The aerosol-forming substrate may comprise tobacco. The aerosol-forming substrate may comprise a tobacco-containing material containing volatile tobacco flavour compounds, which are released from the aerosol-forming substrate upon heating. The aerosol-forming substrate may alternatively comprise a non-tobacco-containing material. The aerosol-forming substrate may comprise homogenised plant-based material.

The aerosol-forming substrate may comprise at least one aerosol-former. An aerosol-former is any suitable known compound or mixture of compounds that, in use, facilitates formation of a dense and stable aerosol and that is substantially resistant to thermal degradation at the temperature of operation of the system. Suitable aerosol-formers are well known in the art and include, but are not limited to: polyhydric alcohols, such as triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. Aerosol formers may be polyhydric alcohols or mixtures thereof, such as triethylene glycol, 1,3-butanediol and glycerine. The aerosol-former may be propylene glycol. The aerosol former may comprise both glycerine and propylene glycol.

The aerosol-forming substrate may also be provided in a liquid form. The liquid aerosol-forming substrate may comprise other additives and ingredients, such as flavourants. The liquid aerosol-forming substrate may comprise water, solvents, ethanol, plant extracts and natural or artificial flavours. The liquid aerosol-forming substrate may comprise nicotine. The liquid aerosol-forming substrate may have a nicotine concentration of between about 0.5% and about 10%, for example about 2%. The liquid aerosol-forming substrate may be contained in a liquid storage portion of the aerosol-generating article, in which case the aerosol-generating article may be denoted as a cartridge.

As an alternative to an electrically resistive heating element, the heating element may be configured as an induction heating element. The induction heating element may comprise an induction coil and a susceptor. In general, a susceptor is a material that is capable of generating heat, when penetrated by an alternating magnetic field. When located in an alternating magnetic field. If the susceptor is conductive, then typically eddy currents are induced by the alternating magnetic field. If the susceptor is magnetic, then typically another effect that contributes to the heating is commonly referred to hysteresis losses. Hysteresis losses occur mainly due to the 1movement of the magnetic domain blocks within the susceptor, because the magnetic orientation of these will align with the magnetic induction field, which alternates. Another effect contributing to the hysteresis loss is when the magnetic domains will grow or shrink within the susceptor. Commonly all these changes in the susceptor that happen on a nano-scale or below are referred to as “hysteresis losses”, because they produce heat in the susceptor. Hence, if the susceptor is both magnetic and electrically conductive, both hysteresis losses and the generation of eddy currents will contribute to the heating of the susceptor. If the susceptor is magnetic, but not conductive, then hysteresis losses will be the only means by which the susceptor will heat, when penetrated by an alternating magnetic field. According to the invention, the susceptor may be electrically conductive or magnetic or both electrically conductive and magnetic. An alternating magnetic field generated by one or several induction coils heat the susceptor, which then transfers the heat to the aerosol-forming substrate, such that an aerosol is formed. The heat transfer may be mainly by conduction of heat. Such a transfer of heat is best, if the susceptor is in close thermal contact with the aerosol-forming substrate.

The susceptor may be formed from any material that can be inductively heated to a temperature sufficient to generate an aerosol from the aerosol-forming substrate. A preferred susceptor may comprise or consist of a ferromagnetic material or ferri-magnetic material, for example a ferromagnetic alloy, ferritic iron, or a ferromagnetic steel or stainless steel. A suitable susceptor may be, or comprise, aluminium. Preferred susceptors may be heated to a temperature in excess of 250 degrees Celsius.

Preferred susceptors are metal susceptors, for example stainless steel. However, susceptor materials may also comprise or be made of graphite, molybdenum, silicon carbide, aluminum, niobium, Inconel alloys (austenite nickel-chromium-based superalloys), metallized films, ceramics such as for example zirconia, transition metals such as for example iron, cobalt, nickel, or metalloids components such as for example boron, carbon, silicon, phosphorus, aluminium.

Features described in relation to one embodiment may equally be applied to other embodiments of the invention.

The invention will be further described, by way of example only, with reference to the accompanying drawings in which:

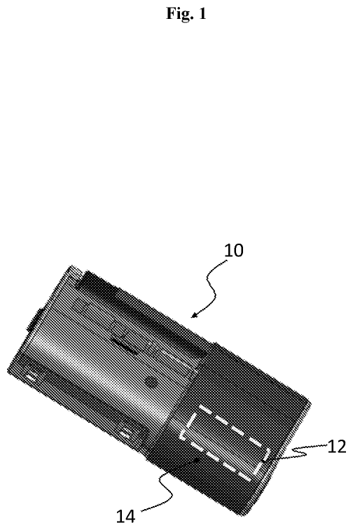

FIG. 1 shows an embodiment of an aerosol-generating device;

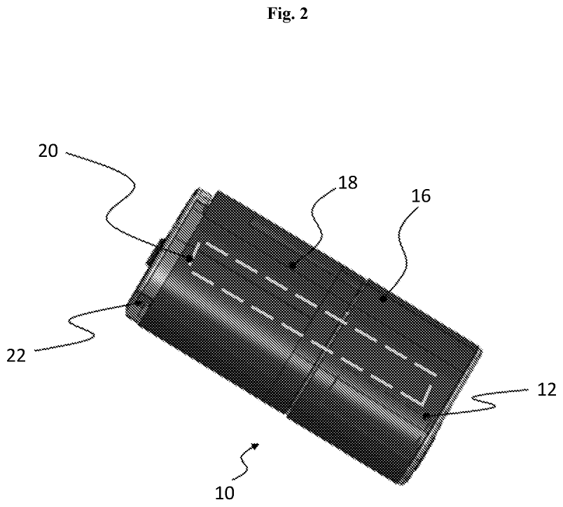

FIG. 2 shows a further embodiment of an aerosol-generating device: and

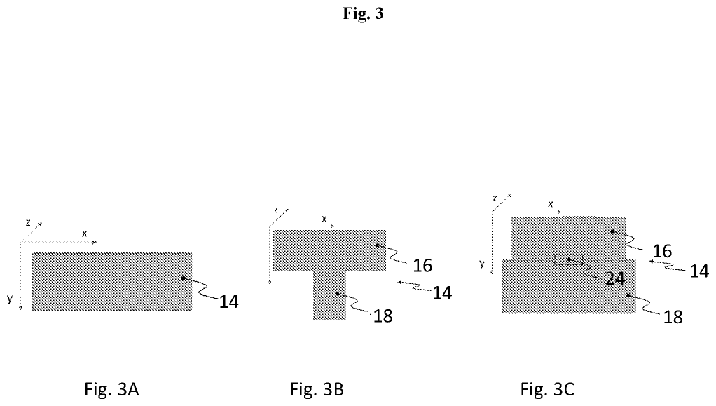

FIG. 3 shows different embodiments of heat dissipation elements employed in the aerosol-generating device.

FIG. 1 shows an aerosol-generating device 10. The aerosol-generating device 10 comprises a heating chamber 12 indicated by the dashed line. The heating chamber 12 is arranged in a proximal area of the aerosol-generating device 10. The heating chamber 12 is open on the proximal end to receive an aerosol-generating article comprising aerosol-forming substrate.

A heat dissipating element in the form of a graphene layer is arranged surrounding the heating chamber 12. The graphene layer dissipates the heat from a heating element away from the heating chamber 12. The heating element is also surrounded by the heat dissipating element.

In the embodiment shown in FIG. 1, the heat dissipating element is arranged solely surrounding the heating chamber 12. In this case, the heat dissipating element dissipates the heat over the surface of the heating chamber 12 such that the surrounding housing of the aerosol-generating device 10 does not comprise hotspots that are hot to the touch.

FIG. 2 shows an embodiment in which the heat dissipation element 14 not only surrounds the heating chamber 12 but extends further in a distal direction into the aerosol-generating device 10.

In more detail, a first portion 16 of the heat dissipation element 14 is arranged surrounding the heating chamber 12. A second portion 18 of the heat dissipation element 14 extends further in a distal direction into the aerosol-generating device 10. The second portion 18 of the heat dissipation element 14 extends into the distal part 20 of the aerosol-generating device 10. As a consequence, the heat from the heating chamber 12 is dissipated more uniformly throughout the aerosol-generating device 10.

FIG. 2 further shows that an inner frame 22 may be provided that defines the heating chamber 12 as well as the distal portion of the aerosol-generating device 10.

FIG. 3 shows different embodiments of the heat dissipation element 14 before assembly. FIG. 3A shows an embodiment in which the heat dissipation element 14 is provided in the form of a rectangular sheet before assembly. This embodiment is preferably employed to only surround the heating chamber 12 with the heat dissipation element 14. However, the rectangular sheet can also be dimensioned such that the heating chamber 12 is surrounded by the heat dissipation element 14 as well as a portion of the aerosol-generating device 10 distal from the heating chamber 12.

FIG. 3B shows an embodiment in which the heat dissipation element 14 is formed from a T-shaped sheet. A first portion 16 of the heat dissipation element 14 that constitutes the ‘head’ of the T-shaped sheet is wrapped around the heating chamber 12 in this embodiment. A second portion 18 of the heat dissipation element 14 that constitutes the ‘stem’ of the T-shaped sheet extends in a distal direction of the heating chamber 12 into the distal portion of the aerosol-generating device 10.

FIG. 3C shows an embodiment in which the heat dissipation element 14 is formed from two rectangular sheets which are connected at a connection portion 24. A first portion 16 corresponding to a first rectangular sheet of the heat dissipating element is wrapped around the heating chamber 12. A second portion 18 corresponding to a second rectangular sheet of the heat dissipating element extends distal from the heating chamber 12 further into the aerosol-generating device 10. For an improved heat transfer, the connection portion 24 physically connects the first portion 16 of the heat dissipating element with the second portion 18 of the heat dissipating element.

1.-15. (canceled)

16. An aerosol-generating device, comprising:
a heating chamber; and
a heat dissipation element arranged at least partly surrounding the heating chamber,
wherein the heat dissipation element is made from graphene.

17. The aerosol-generating device according to claim 16, wherein the heat dissipation element is configured to dissipate heat less in a radial direction then in axial and tangential directions with respect to a longitudinal axis of the heating chamber.

18. The aerosol-generating device according to claim 16, wherein the heat dissipation element is configured as a layer.

19. The aerosol-generating device according to claim 16, wherein the heat dissipation element fully surrounds the heating chamber.

20. The aerosol-generating device according to claim 16, wherein the heat dissipation element extends over the heating chamber in a distal direction.

21. The aerosol-generating device according to claim 16, wherein the heat dissipation element is formed from one of a rectangular sheet, a T-shaped sheet, and two connected rectangular sheets.

22. The aerosol-generating device according to claim 16, further comprising a heating element.

23. The aerosol-generating device according to claim 22, wherein the heating element comprises heating tracks.

24. The aerosol-generating device according to claim 22, wherein the heating element consists of heating tracks.

25. The aerosol-generating device according to claim 22, wherein the heating element is arranged at least partly surrounding the heating chamber.

26. The aerosol-generating device according to claim 22, wherein the heating element is arranged fully surrounding the heating chamber.

27. The aerosol-generating device according to claim 16, wherein the heating chamber is formed by a dimensionally stable inner frame of the aerosol-generating device.

28. The aerosol-generating device according to claim 16, wherein the heating chamber is arranged abutting a proximal end of the aerosol-generating device.

29. The aerosol-generating device according to claim 16, wherein the heating chamber has a cylindrical shape.

30. The aerosol-generating device according to claim 16, wherein the heating chamber is configured to receive an aerosol-generating article comprising aerosol-forming substrate.

31. An aerosol-generating system comprising the aerosol-generating device according to claim 16 and an aerosol-generating article comprising aerosol-forming substrate.
